(19) United States
(12) Patent Application Publication
(10) Pub. No.: US 2015/0081679 A1
(43) Pub. Date: Mar. 19, 2015

(54) FOCUSED SEARCH TOOL

(71) Applicants: Avishek Gyanchand, San Jose, CA (US); Arun Lakshiminarayanan, San Jose, CA (US); Karthik Ravikumar, San Jose, CA (US); Prathyusha Senthil Kumar, San Jose, CA (US)

(72) Inventors: Avishek Gyanchand, San Jose, CA (US); Arun Lakshiminarayanan, San Jose, CA (US); Karthik Ravikumar, San Jose, CA (US); Prathyusha Senthil Kumar, San Jose, CA (US)

(21) Appl. No.: 14/026,363

(22) Filed: Sep. 13, 2013

(51) Int. Cl. G06F 17/30

(52) U.S. Cl. CPC G06F 17/3053; G06F 17/3064
USPC 707/723; 707/769

(57) ABSTRACT

A user may select text, an image, or other content being displayed on a device. The device may generate a search query based on the selection and transmit the search query to a server. Based on the search query, the server may generate multiple search options. The server may rank the generated search options and transmit some or all of the generated search options to the user device. The user device may receive the transmitted search options and present one or more of them in a user interface. The user may activate a search option. The user device may transmit the activated search option to the server, which may respond with search results for the activated search option. The user device may then display the search results to the user.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

The subject matter disclosed herein generally relates to the processing of data. Specifically, the present disclosure addresses systems and methods for focused search.

### BACKGROUND

A user may enter a search query comprising an alphanumeric string into a search tool presented on a web page. The web browser may submit the search query to a search engine. The search engine may find items responsive to the search query and send information about the items to the web browser. The web browser may display the search results to the user. The user may modify the search query and cause the modified search query to be resubmitted to the search engine. The search engine may send a new set of search results, responsive to the modified search query, back to the user's browser.

### BRIEF DESCRIPTION OF THE DRAWINGS

Some embodiments are illustrated by way of example and not limitation in the figures of the accompanying drawings.

FIG. 1 is a network diagram illustrating a network environment suitable for focused search, according to some example embodiments.

FIG. 2 is a block diagram illustrating components of an application server suitable for focused search, according to some example embodiments.

FIG. 3 is a block diagram illustrating components of a client machine suitable for focused search, according to some example embodiments.

FIGS. 4-5 are screen diagrams illustrating a focused search tool, according to some example embodiments.

FIGS. 6-7 are flowcharts illustrating operations used in performing a method of focused search, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to focused search tools. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user may select text, an image, or other content being displayed on a device. The device may generate a search query based on the selection and transmit the search query to a server. Based on the search query, the server may generate multiple search options. The search options modify or replace the original query with one or more search queries related to the first search query. As used herein, “selecting” content on a screen refers to the selection of passive content. For example, a user may select text in a word-processing document which may then be cut and pasted into a different portion of the document. By contrast, “activating” content on a screen refers to activating active content. For example, a user may activate a button, drop-down list, or hyperlink. Thus, if a user selects a hyperlink presented on a web page, the user has selected the passive text presented on the screen, while if a user activates a hyperlink presented on a web page, the user has caused the web browser to load the indicated web page. “Interacting” with content encompasses both selecting and activating. Though particular embodiments are described herein, in which certain displayed elements are selected and others are activated, all forms of interaction are contemplated.

A search tool is an interface element provides a user with the ability to perform an electronic search. The search may be based on a search query. A search query defines the parameters of a search. A search query may include an alphanumeric string, an image, audiovisual data, or any suitable combination thereof. A search query may include filters that exclude results complying with or not complying with the filter. A search query may be composed of multiple elements. An element is a discrete portion of a search query, such as a word or phrase in an alphanumeric string, an image, or a filter.

A focused search tool provides suggestions to a user for one or more search queries based on a search query provided by a user. The suggested search queries may be modified versions of the user-provided search query.

One type of modified search query is a related search query. A related search query may include all of the elements of the original search query and one or more additional elements. As another example, a related search query may include one or more elements of the original search query while omitting one or more elements of the original search query. Alternatively, a related search query may not include any elements of the original search query, but be related based on prior user actions (individual or collective), common misspellings, etc. The prior user actions may be immediately sequential or separated by intermediate actions. For example, a web search engine may present a result set of hyperlinks in response to a search query. The user may choose not to interact with any of the presented hyperlinks but instead submit a second search query. The user may choose not to interact with any result generated by the second search query as well, and submit a third search query. Based on the user interacting with a hyperlink generated by the third search query but not the second search query, the system may choose to treat the third search query as a related search for the original search query.

In some cases, misspellings will be corrected by detection as sequential searches. As one example of this, a user search for “prse” may often be immediately followed by a search for “purse.” In this case, “purse” may be a related search for “prse.” As another example, a user search for “iPhone” may often be followed by a search for “android,” and “android” may be a related search for “iPhone.”

In other cases, misspellings will be corrected by reference to a dictionary. Continuing with the above example of “prse,” the misspelled word may not be found in a dictionary, but words in the dictionary may be within a maximum distance from the misspelled word. For example, the name “Prue” or the word “purse.” These words within the maximum distance may be related searches for “prse.” The distance between words may be measured by the Levenshtein distance or another method of measurement, as is known in the art.

In some embodiments, the additional search criteria serve to focus the search on a particular aspect of the search query.

The search options may allow a user to further refine the search query or filter the search results. In some example embodiments, the search options are based on characteristics of the respective search results such as category, aspect, free shipping, preferred location, buy-it-now, new, used, auction, or any suitable combination thereof.

The server may rank the generated search options and transmit some or all of the generated search options to the user device. For example, the top five generated search options may be transmitted. The user device may receive the transmitted search options and present one or more of them in a user interface. The user may activate a search option from the user interface to cause the activated search option to be executed. The user device may transmit the activated search option to the server, which may respond with refined search results for the activated search option. The user device may then display the refined search results to the user.

A search engine may process the search query to generate results. Results generated by different search engines for the same search query may be different. For example, one search engine may be geared to providing image results while another is geared to providing shopping results. Continuing with this example, submitting a search query comprising “purse” to the two engines could result in an image of a purse from the first engine and a link to a purse retailer from the second engine.

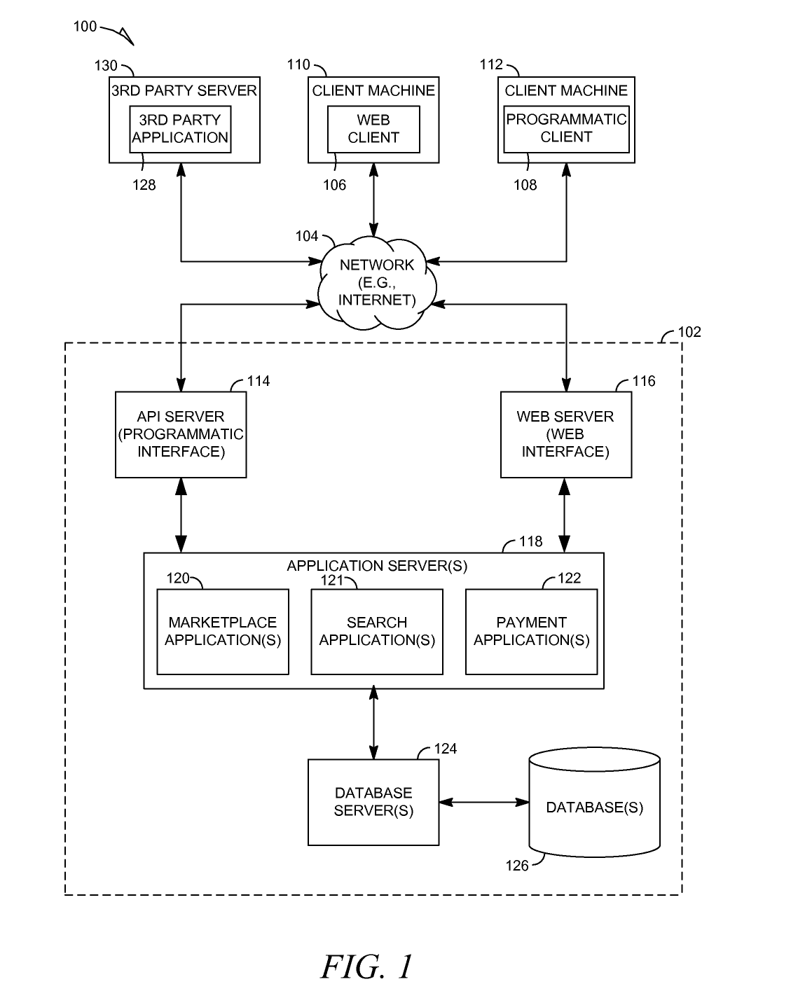

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120, search applications 121, and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The search applications 121 may provide a number of search functions and services to users that access the networked system 102. The search applications 121 may allow users to submit queries and receive results responsive to the queries. The search applications 121 may be linked to or part of the marketplace applications 120. Accordingly, searches may be run by the search application 121 to find items for sale through the marketplace applications 120. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace, search, and payment applications 120, 121, and 122 are shown in FIG. 1 to each form part of the networked system 102, it will be appreciated that, in alternative embodiments, the search applications 121 may form part of a search service that is separate and distinct from the networked system 102. Likewise, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace, search, and payment applications 120, 121, and 122 could also be implemented as standalone software programs, which do not necessarily have networking capabilities.

The web client 106 accesses the various marketplace, search, and payment applications 120, 121, and 122 via the web interface supported by the web server 116. Similarly, the programmatic client 108 accesses the various services and functions provided by the marketplace, search, and payment applications 120, 121, and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The client machine 110 or 112 may present information to a user. For example, the client machine 110 or 112 may be running a web browser presenting a web page. The user may indicate a search query to the client machine 110 or 112. For example, the user may type a search query into a text field. As another example, the user may select a string of text on the screen. In this example, the running application may detect the selected text and automatically interpret it as a search query. The application may delay between the selection of the text and the interpretation of the text as a search query, e.g., to allow the user to choose a different action to perform with the text. The selection of an image may be treated as the selection of text associated with the image (e.g., the caption of a figure or the alt text of an image in a web page). The selection may be detected, e.g., by JavaScript code running in the viewed web page, by a web browser plugin installed into the user's browser, by a web browser supporting this feature, by an external application monitoring the text being displayed and the user's actions, or any suitable combination thereof.

The client machine 110 or 112 may submit the search query to an application server 118 running a search application 121. The application server 118 may modify the search query before submitting the modified search query to the item database (e.g., the database 126). Different modifications may be performed and the quality or quantity of the results analyzed. For example, the search query may be modified to search for results within a certain category (e.g., a product category such as books, games, movies, furniture, etc. or a content category such as news, blogs, fiction, opinion, entertainment, and the like) or with a certain attribute (e.g., produced within a certain date range, located within a geographic area, shipped in a certain way, sold in a particular way, etc.). Based on the analysis of the results, the application server 118 may send one or more of the search queries back to the client machine 110 or 112. The client machine 110 or 112 may then present options to the user corresponding to one or more of the received search queries. The options may indicate the content of the search queries with text, images, color coding, or any suitable combination thereof

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, search, or payment functions that are supported by the relevant applications of the networked system 102.

The client machine 110 or 112 may receive an activation of an option corresponding to a received search query and transmit the corresponding search query to the application server 118. The application server 118 may generate a set of search results based on the received search query and transmit one or more of the search results back to the client machine 110 or 112. The client machine 110 or 112 may present one or more of the received search results to the user. For example, the search results may be presented as a list wherein the user may interact with any result in order to obtain more information for that result.

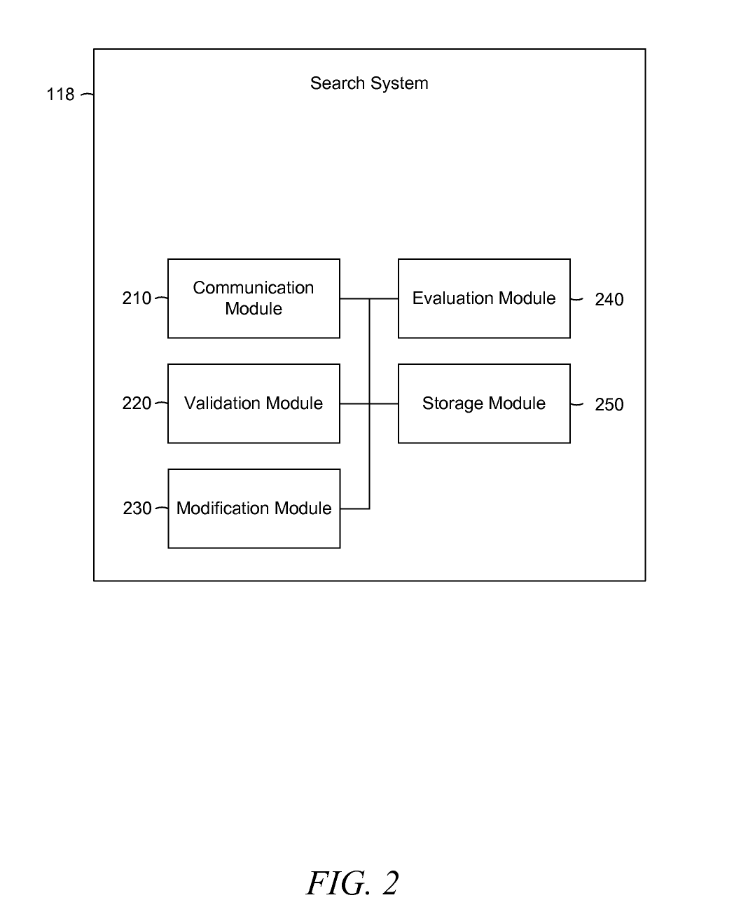

FIG. 2 is a block diagram illustrating components of an application server 118 running a search application 121, according to some example embodiments. The application server 118 is shown as including a communication module 210, a validation module 220, a modification module 230, an evaluation module 240, and a storage module 250, all configured to communicate with each other (e.g., via a bus, shared memory, a switch, or application programming interfaces (APIs)). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 may control communication with the client machine 110 or 112 and the database 126. The communication module 210 may also send data to the storage module 250 for storage on the application server 118 or the database 126.

Upon receiving a search query from a user device (e.g., the client machine 110 or the client machine 112), the communication module 210 sends the search query to the validation module 220 for validation.

The user device may submit the search query to the search application 121 running on the application server 118. The search application 121 may modify the search query before submitting the modified search query to the item database. Different modifications may be performed and the quality or quantity of the results analyzed. For example, the search query may be modified to search for results within a certain category (e.g., a product category such as books, games, movies, furniture, etc. or a content category such as news, blogs, fiction, opinion, entertainment, and the like) or with a certain attribute (e.g., produced within a certain date range, located within a geographic area, shipped in a certain way, sold in a particular way, etc.). Based on the analysis of the results, the search application 121 may send one or more of the search queries back to the client machine 110 or 112. The client machine 110 or 112 may then present options to the user corresponding to one or more of the received search queries. The options may indicate the content of the search queries with text, images, color coding, or any suitable combination thereof.

The validation module 220 validates the search query. In various embodiments, different tests for validation are performed. For example, the search query may be validated based on its origin, its contents, or both. The origin of a query may be validated by determining if the user's device is an authorized device, determining if the user is an authorized user, or both. In some example embodiments, the determination that the user is an authorized user is made based on the user providing a username and password. The contents of a search query may be validated for structural validity, topical validity, or both. A search query has structural validity when the form of the query is in compliance with the requirements of the search engine. For example, a malicious user may attempt to inject code into the system with a malformed query designed to cause the system to perform operations unintended by the programmer of the system. Such a malformed query would lack structural validity. Tests for structural validity may include checking for a maximum size of a search query, checking for invalid characters in a search string, checking for correct formatting of multimedia elements, or any suitable combination thereof. A search query has topical validity when the terms of the query comply with the terms of use of the search engine. For example, searches based on profanity, controversial topics (e.g., religion or politics), or particular brands (e.g., a competitor's brand or an advertiser's competitor's brand) may be topically invalid. If the validation module 220 determines that the search query is not valid, then the communication module 210 may inform the client machine 110 or 112 that no search will be performed. In some example embodiments, no validation is performed.

The modification module 230 may analyze the search query and modify the search query in a number of ways to generate search options. In some example embodiments, an objective of the modification is to more quickly direct the user to the desired results. For example, in a prior art use case, the user might submit a search query, generate a list of results, realize that the results are not responsive to the question the user had in mind, modify the search query, generate a new list of results, and continue to repeat the process until a desired search result is generated. The modifications generated by the modification module 230 may serve to reduce the number of iterations required before the user finds a desired search result. The modification may be based on prior activity by this user, prior activity by users in general, prior activity by friends of the user, or other heuristics such as correcting misspelling, promoting advertised items, or identifying item categories. Example modifications include adding filters, correcting misspelling, adding search terms, deleting search terms, and replacing the search query with a related search query. Example filters that may be added to the query include: category, aspect, free shipping, preferred location, buy-it-now, new, used, auction, or any suitable combination thereof.

To illustrate, if the search query is “Dickens,” the system may determine that many search results for the search query are in the category of “Books.” This may be determined by running the query and identifying the category for each result. Alternatively, popular categories for results of various search queries may be determined ahead of time and stored for later access. In this case, the system need not run the query at the time it is received, but may access the pre-determined category or categories for the search query. After determining that many search results for the search query “Dickens” are found in the “Books” category, the search option of “Dickens” in the category “Books” may be one of the generated search options. Likewise, an aspect such as “hardcover” or “softcover” may be added, based on a determination that many results have that aspect, a determination that many users in the past have added a filter based on the aspect in the past, or both.

Some filters may be based on user information. For example, if the user's location is known, one of the generated search options may filter the search results to limit the results to items within a certain radius of the user. The user's location may be known based on a global positioning system (“GPS”) location of a device associated with the user, an address provided by the user, or any suitable combination thereof. As another example, a user may set a preference indicating that items with “free shipping” are preferred. Based on this preference, one of the generated search options may filter the search results to include only items for sale with free shipping.

A modified search may also be generated based on the search histories of other users, the search history of this user, or both. To illustrate, if many users search for “Dickens” only to later search for “Oliver Twist” before finding search results of interest (e.g., before finding search results that receive further interaction from the user), then the search query may be modified from “Dickens” to the related search of “Oliver Twist.” The sequence of events leading to each interaction may be stored in a database and analyzed. In this illustration, the sequence of events would be a search for “Dickens” followed by a search for “Oliver Twist” followed by an interaction with an item of interest. Other sequences may include more or fewer steps. The behavior of a group of users may be aggregated to identify sequences of events that occur with greater frequency. The frequency of past sequences of events may be used as a proxy for the probability of future sequences of events. As another example, if this user has interacted with many items that are parts for a 1957 Chevy, a search for “windshield wipers” may be recognized as a search for a car part, and the additional terms “1957” and “Chevy” added to the search query to create a modified search query.

A user may interact with a search result in a variety of ways, such as clicking on a link or image associated with the search result or interacting with an item for sale represented by the search result. A user may, among other things, interact with an item for sale by placing a bid on the item, buying the item for a fixed price, making an offer on the item, or adding the item to a watch list.

The evaluation module 240 may evaluate each of the modified search queries and generate a ranking. The ranking may be based on a single criterion or multiple combined criteria. Criteria may be combined based on a weighted numerical combination or a hierarchy of factors. For example, in a hierarchical combination, one criterion may be considered to be the most important, but another criterion may be used as a tie-breaker. When a weighted numerical combination is used, numerical values may be generated for each criterion, which are then multiplied by a corresponding weight value and summed to generate a combined numerical value. The combined numerical value may be used to rank the queries. Possible ranking criteria include, but are not limited to, relevance, number of results, and popularity. For example, modified search queries with greater numbers of results may be ranked higher than modified search queries with fewer results. Similarly, modified search queries are more popular (e.g., have been run more often) may be ranked higher than modified search queries that are less popular.

The relevance of a modified search query may be determined by combining the relevance of the results provided by the modified search query. For example, the relevance of an individual result may be based on how strongly the result responds to a search query. To illustrate, if a search query is “Dickens” and the results are items for sale, then an item that contains “Dickens” in the title and repeatedly in the text description of the item may have a higher relevance than an item that only mentions “Dickens” once. The relevance of the individual results for a search query may be aggregated to determine the relevance of the search query. In one example embodiment, the relevance of a modified search query is based on the relevance of the results for that search query to the unmodified search query. To illustrate, if the original search query is “Dickens” and the modified search query is “Oliver Twist,” then each result for the modified search query may be tested to determine its relevance to “Dickens,” as discussed above. The aggregated relevance to the original search query may be determined, and this aggregated relevance used as a relevance value for the modified search query.

After the modified search queries have been ranked, the communication module 210 may send the highest-ranked modified search queries to a client device (e.g., the client machine 110 or 112). The communication module 210 may subsequently receive a chosen modified search query from the client device, and may submit the chosen modified search query to an item database (e.g., to the database 126 via the database server 124) and receive the search results for the chosen modified search query. After receiving the search results from the database, the communication module 210 may send the search results to the client device, for display to the user.

The storage module 250 may store the results of searches and subsequent user actions. In some example embodiments, modified search queries are stored in the storage module 250 for later retrieval by the modification module 230, the evaluation module 240, or both. For example, the search options of “Dickens” in the category “Books” and “Oliver Twist” as modified search queries for the search query “Dickens” may be cached by the storage module 250 for later use. In other example embodiments, search query modifications are generated dynamically by the modification module 230 and ranked by the evaluation module 240 in response to the receipt of each search query.

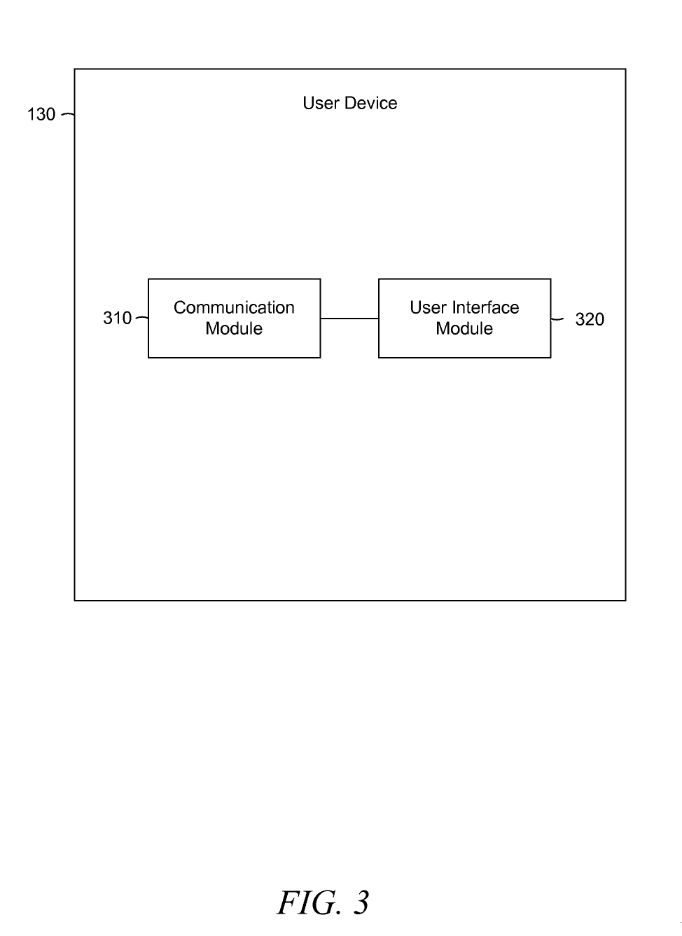

FIG. 3 is a block diagram illustrating components of the client machine 110 or 112, according to some example embodiments. The client machine 110 or 112 is shown as including a communication module 310 and a user interface module 320, configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 310 may communicate with the application server 118, the network 104, or any suitable combination thereof. Information received via the communication module 310 may be presented (e.g., displayed on a display device) via the user interface module 320. Information may be selected or search queries may be entered by a user using a user interface presented by the user interface module 320. The search queries may be communicated to the application server 118 via the communication module 310. The application server 118 may respond to the search queries with a set of modified search queries, received by the communication module 310.

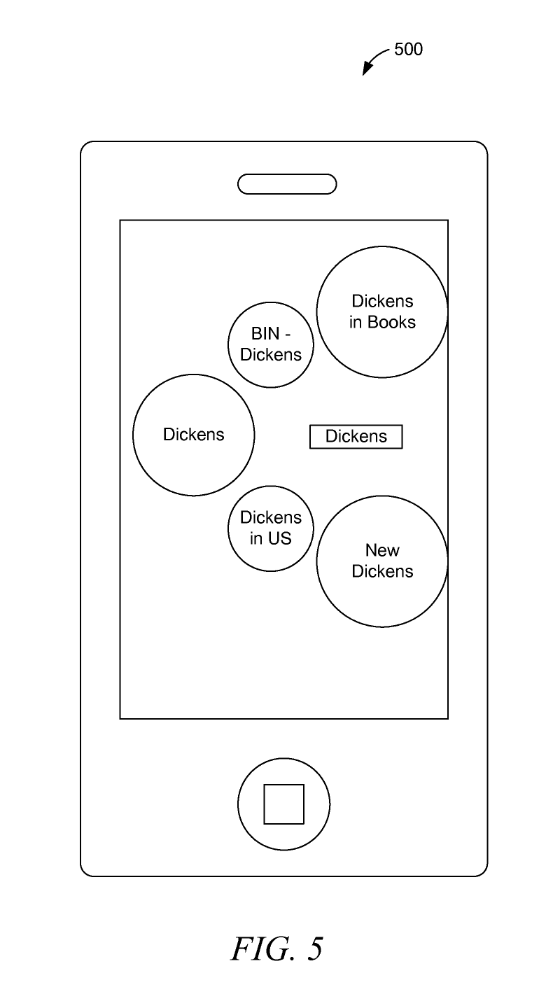

In some example embodiments, the modified search queries are received along with information to be used to determine how the modified search queries are displayed. For example, a modified search query may be associated with attributes including a shape, a location, a size, a color, or any suitable combination thereof. The attributes may then be used by the user interface module 320 to place a UI element associated with the modified search query on the screen in the indicated fashion. In other example embodiments, more processing is performed by the user interface module. For example, a modified search query may be associated with attributes including a rank, a number of results, relevance, or any suitable combination thereof. Based on these attributes, the user interface module 320 may determine how to display a UI element associated with the modified search query. To illustrate, a modified search query associated with a high ranking may be displayed more prominently than a modified search query associated with a low ranking. The more prominent display may be achieved by using a particular shape for the UI element, using a larger UI element, displaying the UI element in a different color, placing the UI element in a more central position, or any suitable combination thereof. An example user interface for presenting the modified search queries is shown in FIG. 5, discussed below. The user's interaction with a chosen modified search query may be received by the user interface module 320 and communicated to the application server 118 by the communication module 310. Search results generated from the chosen search query may be received by the communication module 310 and presented to the user by the user interface module 320.

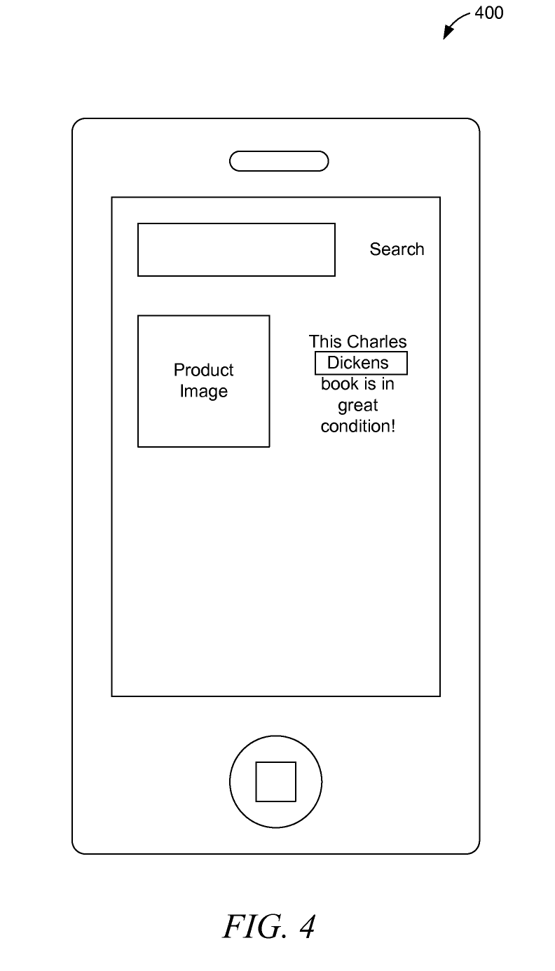

FIG. 4 is a screen diagram 400 illustrating a type of focused search, according to some example embodiments. The screen diagram 400 may be generated by the user interface module 320, discussed above. As shown in the screen diagram 400, the user has selected text containing “Dickens” in a product description shown on a web page. In this illustration, the search query is the selected text. In other use cases, a phrase, image, or audio/video file may be selected. When a non-text element is selected, the element itself may be used as the search query, or text associated with the element may be used. For example, if an image in an HTML page is selected, alt text associated with the image may be used as the search query.

FIG. 5 is a screen diagram 500 illustrating a type of focused search, according to some example embodiments. The screen diagram 500 may be generated by the user interface module 320, discussed above with respect to FIG. 3. As shown in the screen diagram 500, five suggested searches are presented to the user based on the selection of “Dickens.” Beginning at the top right, the first suggested search is “Dickens in Books.” The “Dickens in Books” search option, when activated by the user, may cause a search for the term “Dickens” in the category “Books.” Continuing counter-clockwise, the “BIN—Dickens” search option may be used to cause a search for the term “Dickens” among items available for purchase at a fixed price (e.g., “Buy-It-Now” items). The “Dickens” search option may be used to cause a search for the term “Dickens” without additional filters. The “Dickens in US” search option may be used to cause a search for the term “Dickens” among items located in the United States. The “New Dickens” search option may be used to cause a search for the term “Dickens” among new items. The size of each of the search options presented may represent the number of results for each search. For example, if the “Dickens in Books” circle has twice the area of the “BIN—Dickens” circle, there may be twice as many matches for the former search than the latter. Other sizes may be chosen as well. For example, the radius may be proportional to the number of results, or circles of different sizes may be used to indicate the ranking of the searches by result count without the circle sizes being proportional to the number of matches.

The search options may be presented as an overlay on the screen. For example, the web page of FIG. 4 may be dimmed and the circles of FIG. 5 may be presented as white circles with black text superimposed over the web page. In some example embodiments, one or more of the search options may be superimposed over the selection itself.

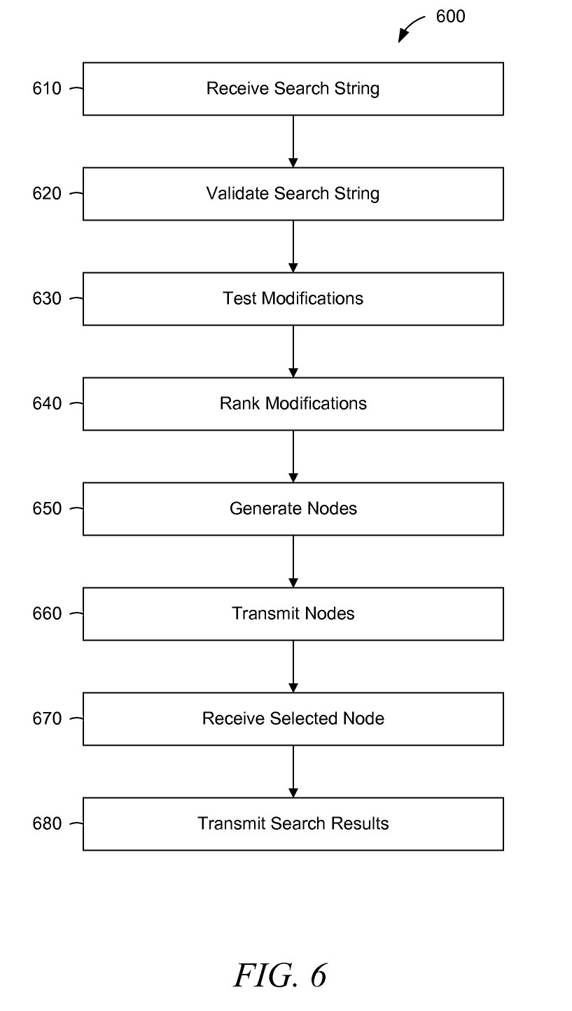

FIG. 6 is a flowchart illustrating operations of a machine (e.g., the search application 121 running on an application server 118) in performing a method of focused search, according to some example embodiments. Operations in the method 600 may be performed by the search application 121 running on an application server 118, using modules described above with respect to FIG. 2. While the various operations of the method 600 are described in reference to the search application 121 running on an application server 118, other devices or systems may be employed to perform the method 600 in other embodiments.

In the method 600, the application server 118 receives a search query (operation 610). For example, the search query may have been generated by a user of the client machine 110 or 112 and transmitted to the application server 118 over the network 104. The application server 118 may validate the search query (operation 620). For example, validation may include determining that the search query contains only valid search characters (e.g., alphanumeric characters), determining that the search query contains no invalid search characters (e.g., control characters with a special meaning to database software), determining that the search query contains no disallowed words (e.g., profanity, trademarks, or other terms that the search provider chooses not to allow a search for), determining that the search query contains only allowed words (e.g., words in a customized dictionary such as a child-friendly dictionary), or any suitable combination thereof. If the search query is invalid, it may be modified to remove invalid portions or the method 600 may be aborted. In some example embodiments, no validation is performed or failure of the validation is ignored.

Continuing with the method 600, the application server 118 may communicate with the database 126 to test a number of modifications to the search query (operation 630). By way of example and not limitation, a number of possible modifications are discussed below. The search query may be combined with a regional filter wherein search results include only items in the user's region. The search query may be combined with a sale type filter wherein search results include only items sold in a certain manner (e.g., buy-it-now, auction, etc.). The search query may be combined with a date filter wherein search results include only items listed or updated within a certain date range (e.g., last 24 hours, last week, last month, last year, Jan. 1, 1980-Aug. 15, 1985, etc.). The search query may be combined with a price filter wherein search results include only items within a certain price range. The search query may be combined with a currency filter wherein search results include only items listed for sale in a certain currency. The search query may be combined with a category filter wherein search results include only items listed in a certain category (e.g., news, blogs, books, cars, etc.). In some example embodiments, multiple filters are combined simultaneously (e.g., news in the U.S. in the last 24 hours, Books available by auction payable in Euros, etc.).

The search modifications chosen in operation 630 may be based on data from a history database of prior user actions. For example, if many users search for “Dickens” only to later search for “Oliver Twist” before finding search results of interest (e.g., before finding search results that receive further interaction from the user), then the search query may be modified from “Dickens” to the related search of “Oliver Twist.” In some example embodiments, the search modifications are based on data from a history database of prior actions of the present user. For example, if the current user frequently searches for items in the category of “Fine Art,” then one of the generated search options for the user might be “Dickens in Fine Art.”

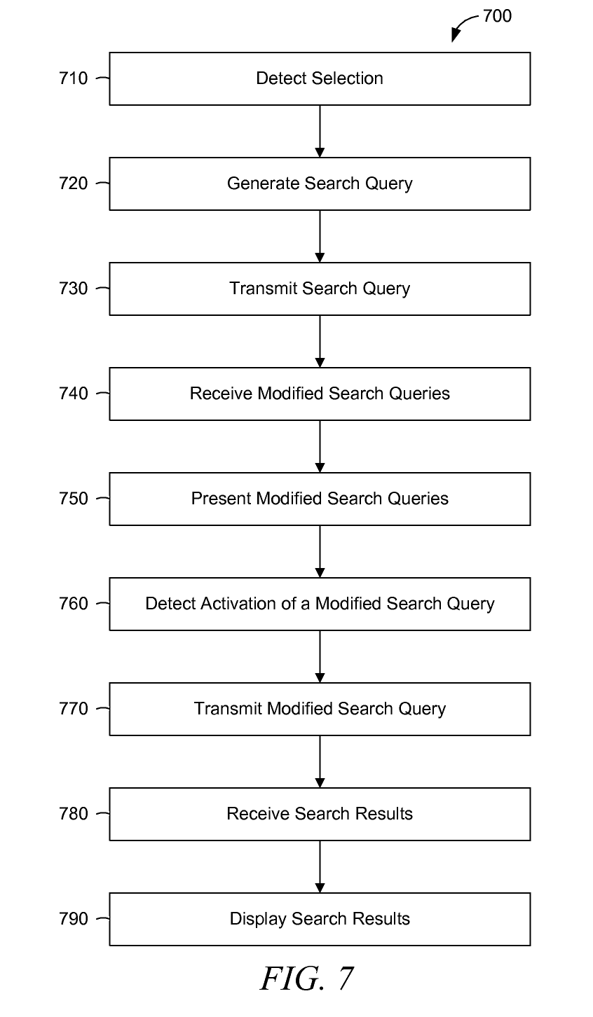

Database queries may be generated based on the modified search queries. Each of the generated modified search queries may be tested (operation 630) by submitting the query to the database 126. Based on the responses generated by the database 126, the modified search queries may be ranked (operation 640). For example, the modified search queries may be ranked on the number of results they generate, with modified search queries that generate more results ranked more highly. Some of the modified search queries may be converted to nodes (operation 650). For example, the five highest-ranked modified search queries may be converted to nodes. In other example embodiments, more or fewer constraints are converted to nodes. The node may be a data object representing the modified search query and suitable for transmission to the user device. The node may include information about the result set for the modified search query (e.g., the number of results for the modified search query, the quality of the results for the modified search query, the ranking of the modified search query, or any suitable combination thereof). The nodes may then be transmitted to the client machine 110 or 112 (operation 660). In some example embodiments, the modified search queries are transmitted to the user device without being encapsulated in nodes. As discussed below with respect to FIG. 7, the client machine 110 or 112 may then present the modified searches to a user who may activate one of the nodes.

The application server 118 may receive a chosen node (operation 670), for example from the client machine 110 or 112. The application server 118 may execute the received node against the database 126 and transmit the generated results (operation 680) to the client machine 110 or 112. Alternatively, the application server 118 may have cached the search results received while ranking the constraints (operation 640) and transmit those results in response to receiving the chosen node.

FIG. 7 is a flowchart illustrating operations of a machine (e.g., the client machine 110 or 112) in performing a method of focused search, according to some example embodiments. Operations in the method 700 may be performed by the client machine 110 or 112, using modules described above with respect to FIG. 3. While the various operations of the method 700 are described in reference to the client machine 110 or 112, other devices or systems may be employed to perform the method 700 in other embodiments.

In the method 700, the client machine 110 or 112 detects a selection (operation 710). For example, the selection may be of one or more words of text, an image, or both. Detection may be based on user delay after the selection, activation of an option presented on a pop-up menu triggered by the selection, occur automatically whenever the user makes a selection, and so forth. Based on the selection, the client machine 110 or 112 may generate a search query (operation 720). For example, if the selection is text, the search query may be the same as the text. If the selection is an image, the search query may be text associated with the image (e.g., a caption of an image in a document, the “alt” text associated with a Hypertext Markup Language (“HTML”) img tag, etc.). The search query may be transmitted to the application server 118 (operation 730).

Modified search queries may be received from the application server 118 (operation 740). For example, the modified search queries may include additional filters as tested by the application server 118 in operation 630 and transmitted by the application server 118 in operation 660, discussed above. The modified search queries may be contained in nodes, as discussed above with respect to FIG. 6. The modified search queries may be presented by the client machine 110 or 112 (operation 750), for example in a user interface as shown in FIG. 5. Each modified search query may be presented in a corresponding user interface element. The user interface elements for the modified search queries may use different values for one or more display attributes. A display attribute affects the manner in which a user interface element is displayed. Example display attributes include size, shape, and color. As an example, one user interface element may have a larger size than another user interface element. As another example, one user interface element may have a different shape than another user interface element. Multiple display attributes may be combined. For example, one user interface element may be a large red square while another user interface element may be a small green circle. The display attributes may be based on information included in the node corresponding to the modified search query. For example, one or more of the display attributes may be based on the rank of the modified search query. As another example, one or more of the display attributes may be based on the number of results for the modified search query. In some example embodiments, different display attributes are based on different data in the node of the modified search query. For example, the size of the user interface element may be based on the number of results for the modified search query while the color of the user interface element is based on the rank of the modified search query and the shape of the user interface element is based on the quality of the results for the modified search query.

The user may activate one of the presented modified search queries (e.g., by clicking on it with a mouse, touching it on a touch-sensitive screen, entering keyboard commands, using voice controls, etc.). Such an activation may be detected by the client machine 110 or 112 (operation 760). The activated search query may be transmitted to the application server 118 (operation 770). In some example embodiments, an identifier for the modified search query is transmitted rather than or in addition to the modified search query itself. Results responsive to the modified search query may be received (operation 780) and presented on a display (operation 790).

According to various example embodiments, one or more of the methodologies described herein may facilitate providing information to a user regarding items of interest. Moreover, one or more of the methodologies described herein may facilitate the generation of sales by an electronic marketplace. Additionally, one or more of the methodologies described herein may facilitate the user's interaction with a search engine.

When these effects are considered in aggregate, one or more of the methodologies described herein may obviate a need for certain efforts or resources that otherwise would be involved in focused search. Efforts expended by a user in identifying items of interest may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

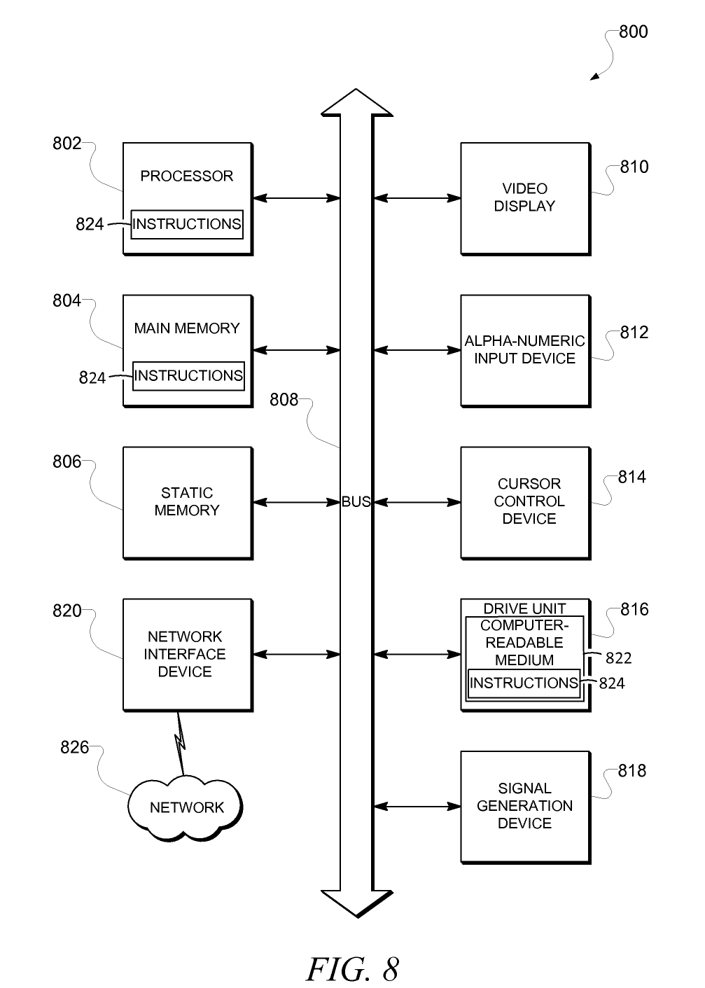

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a tablet, a wearable device (e.g., a smart watch or smart glasses), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a memory;
a processor coupled to the memory and configured to:
detect a selection of information on a screen by a user;
transmit a search query based on the selection to a server;
receive a plurality of modified search queries from the server; and
present a user interface on the screen, the user interface including a plurality of user interface elements operable to cause the transmission of a corresponding one of the plurality of modified search queries to the server, the plurality of user interface elements differing in one or more display attributes.

2. The system of claim 1, wherein the one or more display attributes are selected from the group consisting of size, shape, and color.

3. The system of claim 1, wherein the processor is further configured to:
detect an activation of one of the plurality of user interface elements;
transmit the corresponding one of the plurality of modified search queries to the server;
receive a set of search results based on the transmitted modified search query; and
display the set of search results.

4. The system of claim 1, wherein the button is superimposed over the selected information.

5. The system of claim 1, wherein the modified search queries modify the transmitted search query based on aggregated behavior of a plurality of users.

6. The system of claim 1, wherein the modified search queries modify the transmitted search query based on past behavior of the user that selected the information.

7. The system of claim 1, wherein the selected information is an image and the search query based on the selection is based on an alt text of the image.

8. The system of claim 1, wherein the processor is configured by JavaScript running in a web browser.

9. The system of claim 1, wherein the processor is configured by a plugin to a web browser.

10. The system of claim 1, wherein the values of the one or more display attributes are based on a number of results for the corresponding modified search query.

11. The system of claim 1, wherein the values of the one or more display attributes are based on a frequency of past interactions with the corresponding modified search query.

12. The system of claim 11, wherein the past interactions are past interactions by the user.

13. The system of claim 11, wherein the past interactions are aggregated past interactions by a plurality of users.

14. The system of claim 13, wherein the plurality of users are friends of the user.

15. The system of claim 1, further comprising receiving a rank for each modified search query from the server; and wherein the values of the one or more display attributes are based on the ranks of the modified search queries.

16. The system of claim 15, wherein one of the one or more display attributes is size; and a size of each user interface element is based on the ranking of the corresponding modified search query.

17. The system of claim 16, wherein the rank for each modified search query is based on a number of results for the modified search query.

18. A method comprising:
detecting, by a processor of a machine, a selection of information on a screen by a user;
transmitting a search query based on the selection to a server;
receiving a plurality of modified search queries from the server; and
presenting a user interface on the screen, the user interface including a plurality of user interface elements operable to cause the transmission of a corresponding one of the plurality of modified search queries to the server, the plurality of user interface elements differing in one or more display attributes.

19. The method of claim 18, further comprising:
detecting an activation of one of the plurality of user interface elements;
transmitting the corresponding one of the plurality of modified search queries to the server;
receiving a set of search results based on the transmitted modified search query; and
displaying the set of search results.

20. A non-transitory machine-readable storage medium comprising instructions that, when executed by one or more processors of a machine, cause the machine to perform operations comprising:
detecting a selection of information on a screen by a user;
transmitting a search query based on the selection to a server;
receiving a plurality of modified search queries from the server; and
presenting a user interface on the screen, the user interface including a plurality of user interface elements operable to cause the transmission of a corresponding one of the plurality of modified search queries to the server, the plurality of user interface elements differing in one or more display attributes.
